(19) United States
(12) Patent Application Publication
(10) Pub. No.: US 2012/0007969 A1
(43) Pub. Date: Jan. 12, 2012

(54) METHOD FOR REDUCING LEFT-EYE/RIGHT-EYE CROSSTALK IN A 3D LIQUID CRYSTAL DISPLAY DEVICE AND RELATED DISPLAY SYSTEM

(76) Inventor: Chien-Cheng Lin, Taipei County (TW)

(21) Appl. No.: 12/832,987

(22) Filed: Jul. 8, 2010

(51) Int. Cl. H04N 13/04

(52) U.S. Cl. 348/56; 348/E13.075

(57) ABSTRACT

A liquid crystal display (LCD) system for displaying three-dimensional video includes a backlight module for providing light, a liquid crystal panel for modifying brightness of the light, a backlight driver for controlling the backlight module according to a backlight module control signal, a temperature sensor for detecting temperature to generate a temperature signal, a television processor for increasing duty cycle of the backlight module control signal from a predetermined duty cycle to an increased duty cycle equaling sum of the predetermined duty cycle and an additional duty, and a shutter glasses control module coupled to the television processor for outputting a shutter glasses control signal according to the additional duty. The additional duty is based on the temperature signal.

### BACKGROUND OF THE INVENTION

1. Field of the Invention

The present invention relates to liquid crystal display (LCD) devices for displaying three-dimensional (3D) video, and more particularly to a method for reducing left-eye/right-eye crosstalk in a 3D LCD device and related display system.

2. Description of the Prior Art

LCD displays utilize twisting of liquid crystal molecules to control transmission of light from a backlight module of the LCD display through red, green, and blue subpixel filters to display color images. Typical LCD displays include millions of pixels, each of which must be refreshed each time a displayed image changes. Speed with which the LCD display is able to refresh all of the pixels is referred to as “frame rate.” As LCD display technology has developed, frame rates have increased from 60 Hertz to 120 Hertz, and even 240 Hertz.

Frame rates have quadrupled from 60 Hertz to 240 Hertz, which allows 3D video to be displayed at 120 Hertz by alternating left eye images and right eye images. However, because LCD devices adopt progressive scan for updating the pixels of the LCD device, some pixel rows are updated later than other pixel rows. If pixel rows updated relatively later are still updating while pixel rows updated relatively earlier start being updated again, crosstalk occurs between right eye and left eye images, causing degradation of 3D video quality for the viewer. One factor that affects crosstalk is operating temperature of the LCD device. If the LCD device is part of an end product that has an operating temperature range of 0-40° C., crosstalk level differs depending on the environment in which the LCD device is operated.

### SUMMARY OF THE INVENTION

According to an embodiment, a liquid crystal display (LCD) system for displaying three-dimensional video comprises a backlight module for providing light, a liquid crystal panel for modifying brightness of the light, a backlight driver for controlling the backlight module according to a backlight module control signal, a temperature sensor for detecting temperature to generate a temperature signal, a television processor for increasing duty cycle of the backlight module control signal from a predetermined duty cycle to an increased duty cycle equaling sum of the predetermined duty cycle and an additional duty, and a shutter glasses control module coupled to the television processor for outputting a shutter glasses control signal according to the additional duty. The additional duty is based on the temperature signal.

According to an embodiment, a method of operating a liquid crystal display (LCD) system comprising an LCD panel, a backlight module, a television processor, a temperature sensor and a shutter glasses control module comprises the temperature sensor detecting temperature to generate a temperature signal, the television processor controlling the backlight module to output light at an increased duty cycle equaling sum of a predetermined duty cycle and an additional duty, and the shutter glasses control module outputting a shutter glasses control signal according to the additional duty. The additional duty is based on the temperature signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a 3D LCD system according to an embodiment.

FIG. 2 is a timing diagram illustrating operation of the 3D LCD system according to an embodiment.

FIG. 3 and FIG. 4 are timing diagrams of the backlight ON signal according to other embodiments.

### DETAILED DESCRIPTION

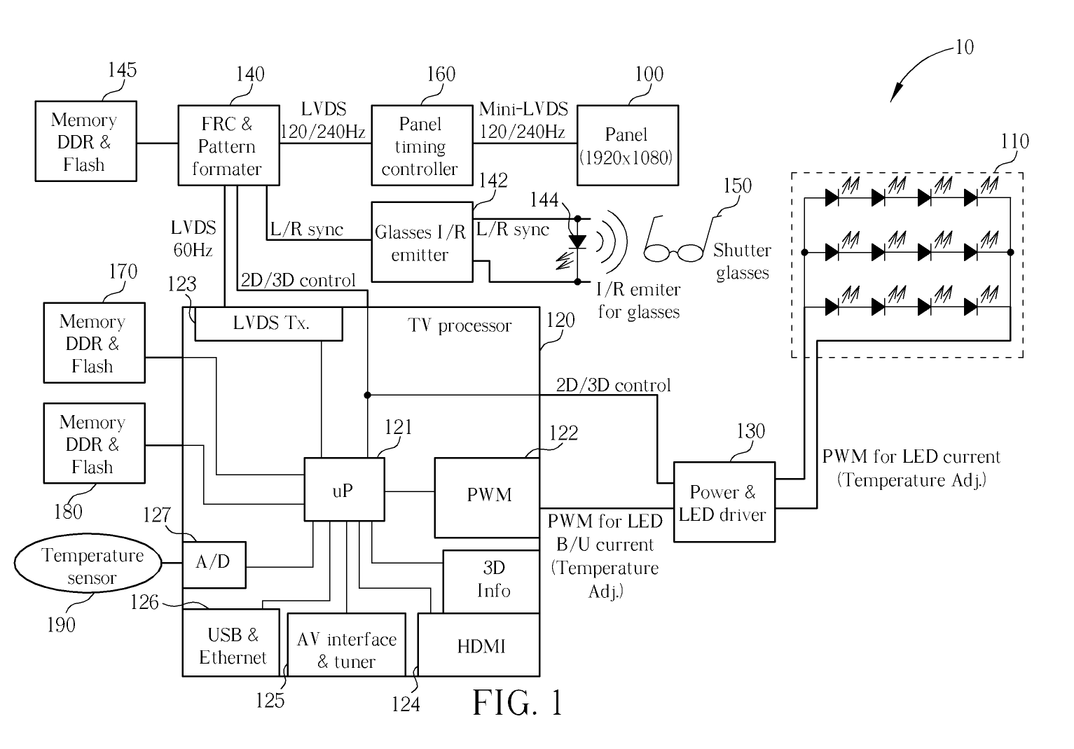

Please refer to FIG. 1, which is a diagram of a 3D LCD system 10 according to an embodiment. The 3D LCD system 10 comprises a panel 100, a backlight module 110, and a television processor 120. The backlight module 110 may be a cold cathode fluorescent lamp (CCFL) or light-emitting diode (LED) backlight module. The television processor 120 comprises a microprocessor 121, a pulse width modulator (PWM) 122, a low voltage differential signal (LVDS) transmitter 123, a High Definition Multimedia Interface (HDMI) module 124, an audio-video (AV) interface and tuner module 125, a Universal Serial Bus (USB) and Ethernet controller 126, and an analog-to-digital converter (ADC) 127. A backlight driver 130 is electrically connected to the backlight module 110, the microprocessor 121, and the PWM 122. The processor outputs two-dimensional (2D) and/or three-dimensional (3D) image control signals to the backlight driver 130, and the PWM 122 outputs a pulse width modulated control signal to the backlight driver 130. The backlight driver 130 drives the backlight module 110 according to the pulse width modulated control signal and the 2D/3D image control signal. The panel 100 is electrically connected to a panel timing controller 160. The panel timing controller 160 is electrically connected to a frame rate conversion (FRC) and pattern formatting module 140. The FRC and pattern formatting module 140 is electrically connected to the microprocessor 121 and the LVDS transmitter 123. The LVDS transmitter 123 sends an LVDS signal at a first frequency, e.g. 60 Hz, to the FRC and pattern formatting module 140. The FRC and pattern formatting module 140 sends an LVDS signal at a second frequency, e.g. 120 Hz or 240 Hz, to the panel timing controller 160, and the panel timing controller sends a mini-LVDS signal at the second frequency to the panel 100 for controlling the panel 100. The FRC and pattern formatting module 140 is further electrically connected to a first memory module 145. An infrared emitter controller 142 is electrically connected to the FRC and pattern formatting module 140 for receiving a left/right synchronization signal. The infrared emitter controller 142 controls an infrared emitter 144 according to the left/right synchronization signal to emit a shutter glasses control signal as pulses of infrared light. The infrared emitter controller 142 and the infrared emitter 144 form a shutter glasses control module. Shutter glasses 150 receive the shutter glasses control signal for alternately turning on/shutting off left and right filters of the shutter glasses 150 in sync with display of the left and right images of the 3D video. The microprocessor 121 is further electrically connected to a second memory module 170 and a keypad/infrared input module 180.

The 3D LCD system 10 further comprises a temperature sensor 190 electrically connected to the ADC 127 for detecting operating temperature and/or ambient temperature of the 3D LCD system 10, and generating a corresponding temperature signal to send to the ADC 127. The ADC 127 converts the temperature signal to a digital temperature signal, and sends the digital temperature signal to the microprocessor 121. The microprocessor 121 controls the PWM 122 according to the temperature signal to increase or decrease duty cycle of the backlight module 110 through the backlight driver 130, so as to increase/decrease the operating temperature and/or ambient temperature. Thus, the temperature sensor 190, the ADC 127, the microprocessor 121, the PWM 122, the backlight driver 130, and the backlight module 110 form a feedback loop for optimizing operating temperature/ambient temperature of the 3D LCD system 10 to reduce left-eye/right-eye crosstalk.

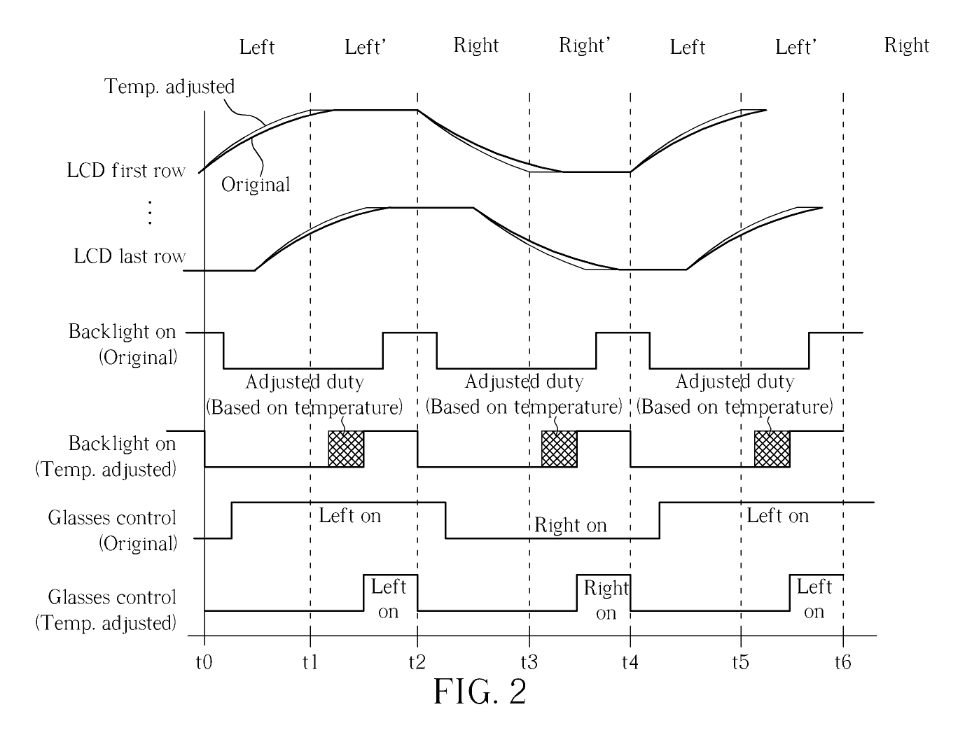

Please refer to FIG. 2, which is a timing diagram illustrating operation of the 3D LCD system 10 according to an embodiment. In FIG. 2, operation of the 3D LCD system 10 is shown in comparison with operation of a 3D LCD system according to a traditional operation method. From time t0 to time t2, a first left image is displayed; from time t2 to time t4, a first right image is displayed; and from time t4 to time t6, a second left image is displayed. In the traditional method, a backlight ON signal is asserted before the end of new image frame, e.g. before time t2, time t4, and time t6 corresponding to display of the first left image, the first right image, and the second left image, and unasserted shortly thereafter. Shutter glasses switch from right filter to left filter (or vice versa) before the backlight ON signal switches from asserted to unasserted. Delay is generated between update of a last row of a panel and update of a first row of the panel. Thus, the asserted period of the backlight ON signal cannot entirely match saturated data for all rows, so the perceived image may include ingredients of the left-eye image and the right-eye image, and the viewer may continue to receive previous image frame information simultaneously with new image frame information (crosstalk).

In the operation of the 3D LCD system 10 shown in FIG. 2 (“temp. adjusted”), duty of a backlight ON signal is adjusted based on temperature measured by the temperature sensor 190. For example, additional duty immediately precedes pulses of the backlight ON signal ending at time t2, time t4, and time t6 (indicated by hashing). By increasing duty of the backlight ON signal, operating temperature of the backlight module 110 increases, which speeds up display of the first left image to time t1, as well as display of the first right image and the second left image to time t3 and time t5, respectively. Brightness of the backlight module 110 is increased by increasing the duty of the backlight ON signal. Thus, duty of the shutter glasses control signal received by the shutter glasses 150 may decreased relative to increase of the duty of the backlight ON signal, as shown in FIG. 2. During display of the first left image, the left filter of the shutter glasses 150 is turned on in a period when the first row and the last row of the panel 100 are both fully updated. The period may correspond to an asserted period of the backlight ON signal minus the additional duty. During display of the first right image, the right filter of the shutter glasses 150 is turned on in a period when the first row and the last row of the panel 100 are both fully updated. Thus, crosstalk is reduced while maintaining the same brightness.

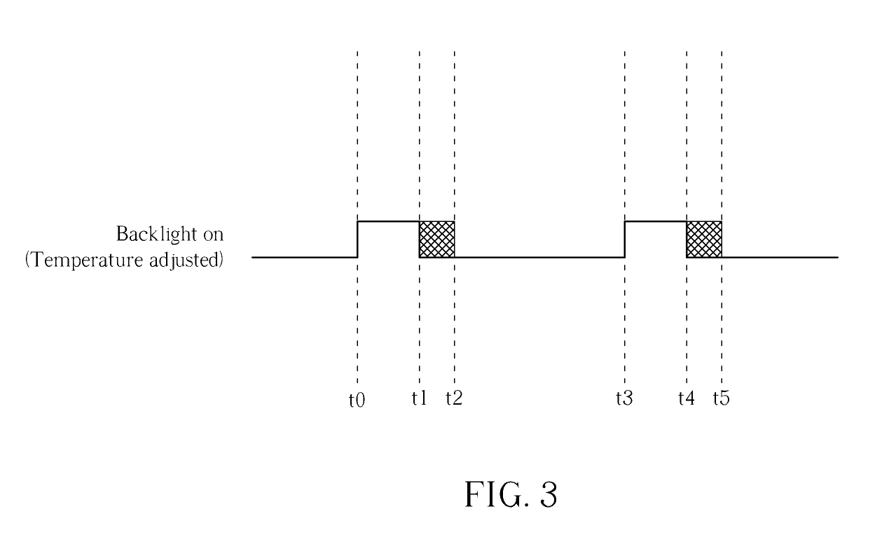

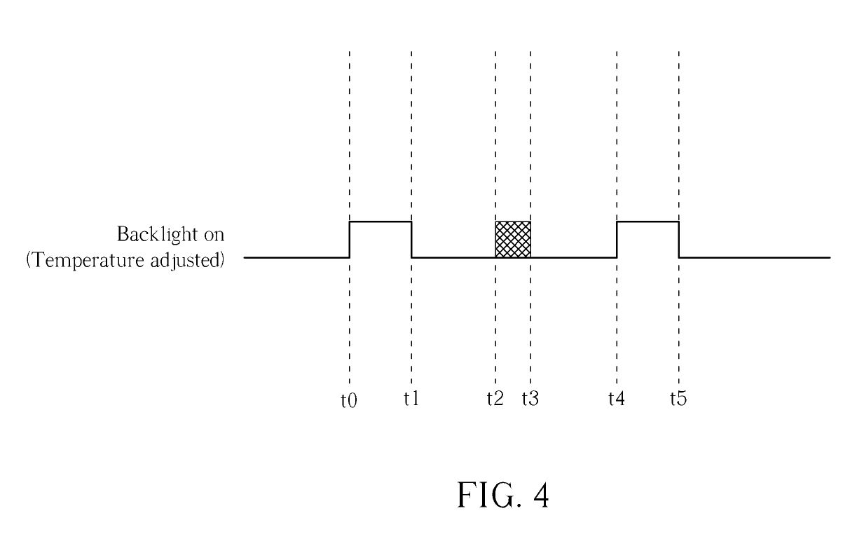

Please refer to FIG. 3 and FIG. 4, which are timing diagrams of the backlight ON signal according to other embodiments. As shown in FIG. 3, the additional duty may be added immediately following the pulses of the backlight ON signal ending at time t1 and time t4. The additional duty may run from time t1 to time t2, and from time t4 to time t5. As shown in FIG. 4, the additional duty may be added at a time t2 following a trailing edge of a first pulse of the backlight ON signal, and preceding a leading edge of a second pulse of the backlight ON signal. The first pulse may run from time t0 to time t1, and the second pulse may run from time t4 to time t5.

In the 3D LCD system 10 shown in FIG. 2, 3D image left-eye/right-eye crosstalk is reduced by actively adjusting LCD operating temperature. Temperature adjustment is achieved through use of control mechanisms common to current generation liquid-type display devices (TV, monitor, public display, etc.).

Those skilled in the art will readily observe that numerous modifications and alterations of the device and method may be made while retaining the teachings of the invention.

What is claimed is:

1. A liquid crystal display (LCD) system for displaying three-dimensional video, the LCD system comprising:
a backlight module for providing light;
a liquid crystal panel for modifying brightness of the light;
a backlight driver for controlling the backlight module according to a backlight module control signal;
a temperature sensor for detecting temperature to generate a temperature signal;
a television processor for increasing duty cycle of the backlight module control signal from a predetermined duty cycle to an increased duty cycle equaling sum of the predetermined duty cycle and an additional duty, wherein the additional duty is based on the temperature signal; and
a shutter glasses control module coupled to the television processor for outputting a shutter glasses control signal according to the additional duty.

2. The LCD system of claim 1, wherein the shutter glasses control module reduces duty cycle of the shutter glasses control signal according to the additional duty of the increased duty cycle.

3. The LCD system of claim 2, wherein the shutter glasses control module reduces duty cycle of the shutter glasses control signal when the additional duty of the increased duty cycle increases.

4. The LCD system of claim 1, wherein the additional duty is added as additional duty pulses, each additional duty pulse ending at a leading edge of each predetermined duty pulse of the predetermined duty cycle.

5. The LCD system of claim 1, wherein the additional duty is added as additional duty pulses, each additional duty pulse beginning at a trailing edge of each predetermined duty pulse of the predetermined duty cycle.

6. The LCD system of claim 1, wherein the additional duty is added as additional duty pulses, each additional duty pulse beginning after a trailing edge of one predetermined duty pulse of the predetermined duty cycle, and ending before a trailing edge of another predetermined duty pulse of the predetermined duty cycle.

7. The LCD system of claim 1, wherein the television processor comprises:
a pulse width modulator for generating the backlight module control signal;
a microprocessor for controlling the pulse width modulator to generate the backlight module control signal based on a digital temperature signal; and
an analog-to-digital converter for converting the temperature signal to the digital temperature signal;
wherein the additional duty is based on the digital temperature signal.

8. The LCD system of claim 1, wherein the backlight module is a light-emitting diode (LED) backlight module.

9. A method of operating a liquid crystal display (LCD) system comprising an LCD panel, a backlight module, a television processor, a temperature sensor and a shutter glasses control module, the method comprising:
the temperature sensor detecting temperature to generate a temperature signal;
the television processor controlling the backlight module to output light at an increased duty cycle equaling sum of a predetermined duty cycle and an additional duty, wherein the additional duty is based on the temperature signal; and
the shutter glasses control module outputting a shutter glasses control signal according to the additional duty.

10. The method of claim 9, wherein the shutter glasses control module outputting the shutter glasses control signal according to the additional duty comprises the shutter glasses control module reducing duty cycle of the shutter glasses control signal according to the additional duty.

11. The method of claim 10, wherein the shutter glasses control module reducing duty cycle of the shutter glasses control signal according to the additional duty is the shutter glasses control module reducing the duty cycle of the shutter glasses control signal when the additional duty increases.

12. The method of claim 9, wherein the television processor controlling the backlight module to output light at the increased duty cycle equaling sum of the predetermined duty cycle and the additional duty is the television processor adding the additional duty as additional duty pulses, each additional duty pulse ending at a leading edge of each predetermined duty pulse of the predetermined duty cycle.

13. The method of claim 9, wherein the television processor controlling the backlight module to output light at the increased duty cycle equaling sum of the predetermined duty cycle and the additional duty is the television processor adding the additional duty as additional duty pulses, each additional duty pulse beginning at a trailing edge of each predetermined duty pulse of the predetermined duty cycle.

14. The method of claim 9, wherein the television processor controlling the backlight module to output light at the increased duty cycle equaling sum of the predetermined duty cycle and the additional duty is the television processor adding the additional duty as additional duty pulses, each additional duty pulse beginning after a trailing edge of one predetermined duty pulse of the predetermined duty cycle, and ending before a trailing edge of another predetermined duty pulse of the predetermined duty cycle.
